(19) United States
(12) Patent Application Publication
(10) Pub. No.: US 2019/0311382 A1
(43) Pub. Date: Oct. 10, 2019

(54) SYSTEMS, METHODS, AND STORAGE MEDIA FOR CREATING A BOOK PRODUCT

(71) Applicant: Pas Mal, LLC, Dover, DE (US)

(72) Inventors: Jim Hull, Emeryville, CA (US); Demetria McAleer, Emeryville, CA (US); Tim Musgrove, Emeryville, CA (US); Matt Oesterle, Emeryville, CA (US); Emillie Rennie, Emeryville, CA (US); Robin Walsh, Emeryville, CA (US)

(73) Assignee: Pas Mal, LLC, Dover, DE (US)

(21) Appl. No.: 16/379,648

(22) Filed: Apr. 9, 2019

Related U.S. Application Data
(60) Provisional application No. 62/655,130, filed on Apr. 9, 2018.

(51) Int. Cl. G06Q 30/02

(52) U.S. Cl. CPC G06Q 30/0202; H04L 67/10; G06Q 30/0206

(57) ABSTRACT

Systems, methods, and storage media are disclosed. Quantitative and qualitative market data from a marketplace indicating consumer interest or demand in book-products are received. Quantitative and qualitative data characteristic data relating to characteristics of existing book-products in the marketplace are received. A formula based on the market data and the characteristic data, is applied to define an opportunity space for at least one potential new book-products. the results of the application of the formula are store the at least one formula in a database; and create a book product based on the formula.

### CROSS-REFERENCE TO RELATED APPLICATIONS

The present application claims benefit from U.S. Provisional Application Ser. No. 62/655,130 filed on Apr. 9, 2018, the disclosure of which is incorporated herein by reference in its entirety.

### FIELD OF THE DISCLOSURE

The present disclosure relates to systems, methods, and storage media for creating a book product.

### BACKGROUND

According to the association of American Publishers, almost half of all books were sold online. Typically, online sales is through a merchant such as AMAZON™ or BARNES AND NOBLE™. Such vendors present web sites which allow consumers to search books in various manners, such as through predefined categories or keywords. The search terms can be used to track the most searched books on the web site.

### SUMMARY

The implementations disclosed herein provide tools for determining a market opportunity for a given search term(s) (referred to as a “keyphrase” herein), for the purpose of developing a product, such as a book product, related to that keyphrase. Implementations can receive market data, from the Amazon API, for example. For a given keyphrase (such as a search term used by a consumer when shopping for books online, implementations determine information such as: aggregate data about the keyphrase, data on products that rank in a search for the keyphrase, and data on products related to the keyphrase. Implementations can provide decision support for producers of products in the development of products, such as book products or can be used to directly design products. In other words, the implementations leverage search terms to create new books and other products that are likely to be successful.

One aspect of the present disclosure relates to a system. The system may include one or more hardware processors configured by machine-readable instructions. The processor(s) may be configured to receive quantitative and qualitative market data from a marketplace indicating consumer interest or demand in book-products. The processor(s) may be configured to receive quantitative and qualitative characteristic data relating to characteristics of existing book-products in the marketplace. The processor(s) may be configured to apply at least one formula that determines an opportunity space for at least one potential new book-products based on the data. The results of the formula may specify, for each of the at least one potential new book product, a consumer need and a keyphrase that represents what a representative portion of the consumer market uses to search for book products related to the consumer need. The processor(s) may be configured to store the results in a database. A book product can be created based on the formula.

Another aspect of the present disclosure relates to a method. The method may include receiving quantitative and qualitative market data from a marketplace indicating consumer interest or demand in book-products. The method may include receiving quantitative and qualitative characteristic data relating to characteristics of existing book-products in the marketplace. The method may include applying at least one formula that determines an opportunity space for at least one potential new book-products based on the data. The results of the formula may specify, for each of the at least one potential new book product, a consumer need and a keyphrase that represents what a representative portion of the consumer market uses to search for book products related to the consumer need. The method may include storing the results in a database. The method may include designing and/or creating a book product based on the formula.

Yet another aspect of the present disclosure relates to a non-transient computer-readable storage medium having instructions embodied thereon, the instructions being executable by one or more processors to perform a method. The method may include receiving quantitative and qualitative market data from a marketplace indicating consumer interest or demand in book-products. The method may include receiving quantitative and qualitative characteristic data relating to characteristics of existing book-products in the marketplace. The method may include applying at least one formula that determines an opportunity space for at least one potential new book-products based on the data. The formula may specify, for each of the at least one potential new book product, a consumer need and a keyphrase that represents what a representative portion of the consumer market uses to search for book products related to the consumer need. The method may include storing the at least one formula in a database. The method may include creating a book product based on the formula.

These and other features, and characteristics of the present technology, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

FIG. 1 illustrates a computer architecture in accordance with one or more implementations.

FIG. 2 illustrates a method in accordance with one or more implementations.

FIG. 3 illustrates an example of a User Interface of one or more implementations.

### DETAILED DESCRIPTION

Implementations receive input data such as: which products rank against a search for the keyphrase on Amazon.com, those products' sales ranks, and those products' prices. The data collection is at the level of the keyphrase used by consumers to shop for book products. Formulas are then applied to this data in order to obtain estimates of quantities such as: revenue of products, which search terms products convert from, and how much market potential exists around a keyphrase. The implementations can receive sales data on past products and produce the output for display or further manipulation. The data can be displayed in multiple tabs for use by editors and other stakeholders. The Display can be arranged by keyphrase, so that the first step is selecting a keyphrase, and then several tabs display with data specific to that keyphrase. The system can receive user input to add characteristics of products and other data within the tab, which are then taken as inputs to formulas. The output of these formulas is then displayed. Examples of tabs to be displayed include:
Summary tab with aggregate keyphrase data (e.g. average search frequency for keyphrase on Amazon).
Competitors tab giving data on the 12 top products ranking against an Amazon search for the keyphrase and taking user input on those products' attributes.
Positioning tab that takes the user input from the Competitors tab, applies a Callisto formula, and gives recommendations on the Callisto product's competitive angle on the keyphrase (called the product's positioning, often the target audience of the product, e.g. “for beginners”).
Historical performance tab gives sales data from past Callisto products relevant to the keyphrase.
Difficulty grading tab takes user input to generate an estimate of how long Callisto will take to develop a book on the keyphrase.
Differentiated opportunity tab makes revenue estimates for Callisto titles and helps Callisto identify the optimal price point and level of investment in book quality to maximize profit.
Outline template tab. Generates a table of contents and/or outline for a Callisto book on the keyphrase.
Review synopsis tab provides summaries of relevant points from reviews of Amazon products that rank in a search for the keyphrase.
Position lookup tab provides information on products with the same positioning (competitive angle) as the Callisto product, but on different keyphrases.

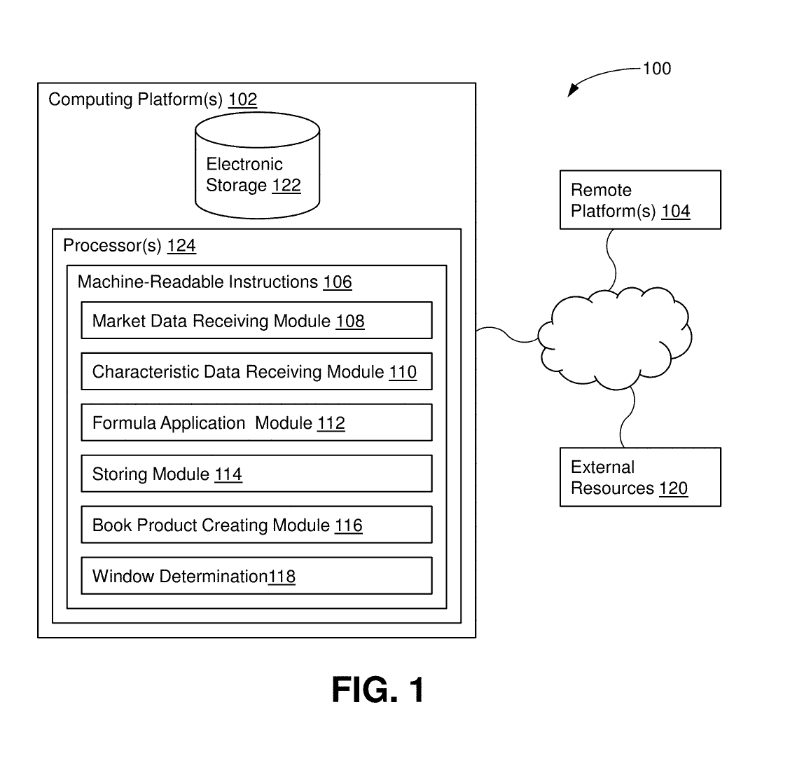

FIG. 1 illustrates an architecture of a system 100 configured to facilitate creation of a book product, in accordance with one or more implementations. In some implementations, system 100 may include one or more servers 102. Server(s) 102 may be configured to communicate with one or more client computing platforms 104 according to a client/server architecture and/or other architectures. Client computing platform(s) 104 may be configured to communicate with other client computing platforms via server(s) 102 and/or according to a peer-to-peer architecture and/or other architectures. Users may access system 100 via client computing platform(s) 104.

Server(s) 102 may be configured by machine-readable instructions 106. Machine-readable instructions 106 may include one or more instruction modules. The instruction modules may include computer program modules. The instruction modules may include one or more of market data receiving module 108, characteristic data receiving module 110, formula application module 112, storing module 114, book product creating module 116, window determination module 118, and/or other instruction modules.

Market data receiving module 108 may be configured to receive quantitative and qualitative market data from a marketplace indicating consumer interest or demand in book-products. For example, the Amazon.com API can be used to receive market data from Amazon.com. Data receiving module 110 may be configured to receive quantitative and qualitative data characteristic data relating to characteristics of existing book-products in the marketplace. Such data can come from various remote sources, such as databases of expert data based on domain expertise.

Formula application module 112 may be configured to apply at least one formula that defines an opportunity space for at least one potential new book-product based on the market data and the characteristic data. The formula may determine, for each of the at least one potential new book product, a consumer need and a keyphrase that represents what a representative portion of the consumer market uses to search for book products related to the consumer need. The at least one formula may further determine, for each potential new book product, a revenue estimate of periodic earnings for existing book products that correspond to the keyphrase. The at least one formula may further determine, for each potential new book product, one or more recommended positions on the keyphrase. By way of non-limiting example, the at least one formula may further determine a break-down of determining the value, including a weighting in page-length, amount of color photos, credentials of author, and quality of paper and binding used to create the book product. The at least one formula can further determine a revenue estimate for each position on the keyphrase, indicating what a revenue a book product provider may expect to achieve.

Storing module 114 may be configured to store the results of the at least one formula in a database. Book product creating module 116 may be configured to create a book product based on the results of the formula. Book product creating module can be coupled to a conventional manufacturing process for creating hard copy books, such as paperback books or hardcover books.

Window determination module 118 may be configured to determine, for at least one recommended position on the keyphrase, one or more windows of production value such that the recommended book product design is to be within the lower and upper limits of the window of value. The position may be based on one or more of the following. The revenue potential of the position on the same or similar keyphrases may match book products is sufficient to justify the cost of production. In some implementations, the recommended positions may indicate one or more approaches to orienting the topic toward one or more various audiences likely to be interested in the topic. In some implementations, the relative strength of may compete products on the same or similar position of the same or similar keyphrases.

In some implementations, server(s) 102, client computing platform(s) 104, and/or external resources 120 may be operatively linked via one or more electronic communication links. For example, such electronic communication links may be established, at least in part, via a network such as the Internet and/or other networks. It will be appreciated that this is not intended to be limiting, and that the scope of this disclosure includes implementations in which server(s) 102, client computing platform(s) 104, and/or external resources 120 may be operatively linked via some other communication media.

A given client computing platform 104 may include one or more processors configured to execute computer program modules. The computer program modules may be configured to enable an expert or user associated with the given client computing platform 104 to interface with system 100 and/or external resources 120, and/or provide other functionality attributed herein to client computing platform(s) 104. By way of non-limiting example, the given client computing platform 104 may include one or more of a desktop computer, a laptop computer, a handheld computer, a tablet computing platform, a NetBook, a Smartphone, a gaming console, and/or other computing platforms.

External resources 120 may include sources of information outside of system 100, external entities participating with system 100, and/or other resources. In some implementations, some or all of the functionality attributed herein to external resources 120 may be provided by resources included in system 100.

Server(s) 102 may include electronic storage 122, one or more processors 124, and/or other components. Server(s) 102 may include communication lines, or ports to enable the exchange of information with a network and/or other computing platforms. Illustration of server(s) 102 in FIG. 1 is not intended to be limiting. Server(s) 102 may include a plurality of hardware, software, and/or firmware components operating together to provide the functionality attributed herein to server(s) 102. For example, server(s) 102 may be implemented by a cloud of computing platforms operating together as server(s) 102.

Electronic storage 122 may comprise non-transitory storage media that electronically stores information. The electronic storage media of electronic storage 122 may include one or both of system storage that is provided integrally (i.e., substantially non-removable) with server(s) 102 and/or removable storage that is removably connectable to server(s) 102 via, for example, a port (e.g., a USB port, a firewire port, etc.) or a drive (e.g., a disk drive, etc.). Electronic storage 122 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Electronic storage 122 may include one or more virtual storage resources (e.g., cloud storage, a virtual private network, and/or other virtual storage resources). Electronic storage 122 may store software algorithms, information determined by processor(s) 124, information received from server(s) 102, information received from client computing platform(s) 104, and/or other information that enables server(s) 102 to function as described herein.

Processor(s) 124 may be configured to provide information processing capabilities in server(s) 102. As such, processor(s) 124 may include one or more of a digital processor, an analog processor, a digital circuit designed to process information, an analog circuit designed to process information, a state machine, and/or other mechanisms for electronically processing information. Although processor(s) 124 is shown in FIG. 1 as a single entity, this is for illustrative purposes only. In some implementations, processor(s) 124 may include a plurality of processing units. These processing units may be physically located within the same device, or processor(s) 124 may represent processing functionality of a plurality of devices operating in coordination. Processor(s) 124 may be configured to execute modules 108, 110, 112, 114, 116, and/or 118, and/or other modules. Processor(s) 124 may be configured to execute modules 108, 110, 112, 114, 116, and/or 118, and/or other modules by software; hardware; firmware; some combination of software, hardware, and/or firmware; and/or other mechanisms for configuring processing capabilities on processor(s) 124. As used herein, the term “module” may refer to any component or set of components that perform the functionality attributed to the module. This may include one or more physical processors during execution of processor readable instructions, the processor readable instructions, circuitry, hardware, storage media, or any other components.

It should be appreciated that although modules 108, 110, 112, 114, 116, and/or 118 are illustrated in FIG. 1 as being implemented within a single processing unit, in implementations in which processor(s) 124 includes multiple processing units, one or more of modules 108, 110, 112, 114, 116, and/or 118 may be implemented remotely from the other modules. The description of the functionality provided by the different modules 108, 110, 112, 114, 116, and/or 118 described below is for illustrative purposes, and is not intended to be limiting, as any of modules 108, 110, 112, 114, 116, and/or 118 may provide more or less functionality than is described. For example, one or more of modules 108, 110, 112, 114, 116, and/or 118 may be eliminated, and some or all of its functionality may be provided by other ones of modules 108, 110, 112, 114, 116, and/or 118. As another example, processor(s) 124 may be configured to execute one or more additional modules that may perform some or all of the functionality attributed below to one of modules 108, 110, 112, 114, 116, and/or 118.

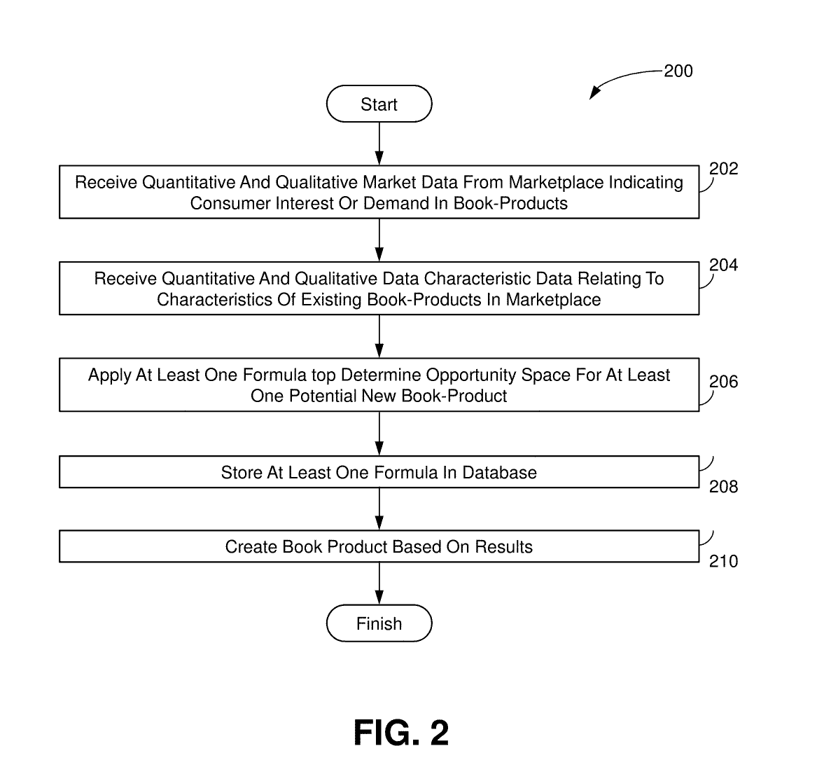

FIG. 2 illustrates a method 200 in accordance with one or more implementations. The operations of method 200 presented below are intended to be illustrative. In some implementations, method 200 may be accomplished with one or more additional operations not described, and/or without one or more of the operations discussed. Additionally, the order in which the operations of method 200 are illustrated in FIG. 2 and described below is not intended to be limiting.

In some implementations, method 200 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 200 in response to instructions stored electronically on an electronic storage medium. The one or more processing devices may include one or more devices configured through hardware, firmware, and/or software to be specifically designed for execution of one or more of the operations of method 200.

An operation 202 may include receiving quantitative and qualitative market data from a marketplace indicating consumer interest or demand in book-products. Operation 202 may be performed by one or more hardware processors configured by machine-readable instructions including a module that is the same as or similar to market data receiving module 108, in accordance with one or more implementations.

An operation 204 may include receiving quantitative and qualitative data characteristic data relating to characteristics of existing book-products in the marketplace. Operation 204 may be performed by one or more hardware processors configured by machine-readable instructions including a module that is the same as or similar to data receiving module 110, in accordance with one or more implementations.

An operation 206 may include applying at least one formula that determines an opportunity space for at least one potential new book-products based on the market data and the characteristic data. The formula may be based on, for each of the at least one potential new book product, a consumer need and a keyphrase that represents what a representative portion of the consumer market uses to search for book products related to the consumer nee. Operation 206 may be performed by one or more hardware processors configured by machine-readable instructions including a module that is the same as or similar to inclusive formula application module 112, in accordance with one or more implementations.

An operation 208 may include storing the results of application of the formula in a database. Operation 208 may be performed by one or more hardware processors configured by machine-readable instructions including a module that is the same as or similar to formula storing module 114, in accordance with one or more implementations.

An operation 210 may include creating a book product based on the results of the formula. Operation 210 may be performed by one or more hardware processors configured by machine-readable instructions including a module that is the same as or similar to book product creating module 116, in accordance with one or more implementations.

The following “pseudocode” describes an example of a formula for determining an opportunity space.

if normalize(keyphrase) not duplicate(keyphrases)
AND
if Search_Frequency(keyphrase) >= 0.50
AND
if Highest(Clickshare,competitors) <= 0.50
AND
if NOT(NavQuery(keyphrase)) OR
(NumUniqueAuthors(competitors) >= 3)
AND
if Highest(SalesRank,competitors) <= 25000
AND
if Num(competitors) WHERE RevenueEstimate >= $1800) >= 2
THEN
Keyphrase.OpportunitySpace = TRUE
ELSE
Keyphrase.OpportunitySPace = False

“normaize” means trimming plural nouns to singulars, stripping off “book” or “books” such that, e.g., “birdhouse book” and “books on birdhouses” both normalize to “birdhouses”
SalesRank means, e.g., the Amazon sales rank among all books
competitors means the top 12 competing books on a bookseller website search for the keyphrase
RevenueEstimate comes from applying another formula such as the media top five revenue of eligible competitors or the formula example set forth below
“eligible competitor” means a book that is not self-published (amateurish poor quality) and that is indeed relevant to the keyphrase
“NavQuery” means a keyphrase where one of the top selling books is mostly searched for by name, e.g. “Ranger Rick's BBQ Guide” rather than just “BBQ guide”. In this case we want to see that Amazon is listing at least a couple other books *not* by “Ranger Rick”

An example of a formula for revenue estimate is set forth below.

(Predicted all channels monthly gross sales at SRP)=$10,165−(0.47*Total Unit Estimate)+(1323*Number of Revenue Keyphrases)+(5.05*Weekly Preorder Unit Goal)−(1205*Number Competitors)+$16,295
Where:
Number of Revenue Keyphrases: A revenue keyphrase is a non-nay query search term from which two or more competitors (e.g. books listed in the search results) convert
Total Unit Estimate: The sum of search volume from each revenue keyphrase
Weekly Preorder Unit Goal: Median weekly unit sales of top five books ranking against the keyphrase.
Number of Competitors: Number of books ranking on the first page of search results for a search for the keyphrase.

Most of the variables and data sources used for calculations could be substituted with similar variables. For example, search frequency data from, e.g. Amazon, could be substituted with search frequency data from, e.g., Google.

The formulas can be altered and updated and additional tabs with additional data, visualizations, or user inputs can be added. The user interface presents data on revenue opportunities isolated by keyphrase. This benefit would be preserved even if the specific formulas, variables, and data inputs were different, as well as if the specific visualizations and layout of the Dashboard were different.

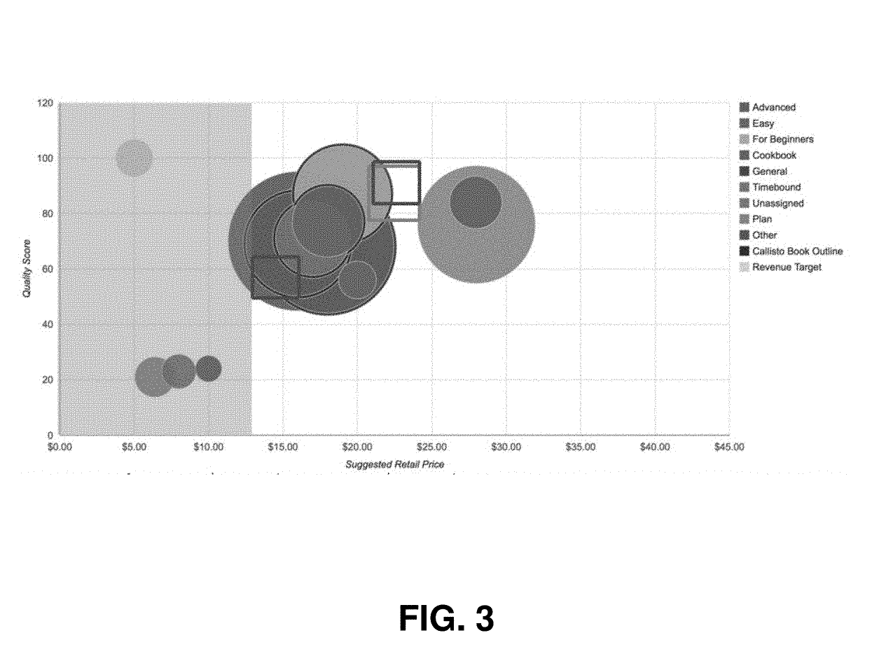

FIG. 3 illustrates a user interface displaying the results in a manner which allows the results of the formula to be efficiently used to facilitate development of book content. However, the data can also be used to understand the revenue opportunity around a keyphrase—for example, the competitive landscape for a keyphrase is also relevant for setting the product's price. As shown in FIG. 3, books resulting from a keyphrase “anti-inflammatory diet” (as normalized) can be plotted with the x=axis indicating cost of the books and the y axis indicating production value (quality score) of the books. The production value relates to the quality of the paper, the quality of the binding, quality of photographs and other production variables. The color coding of the circles indicates an approach to the topic, such as Advanced, For Beginners, . . . . Gaps between the plotted circles indicate strong market opportunities. The squares indicate specific market opportunities. For example, the two red squares indicate two opportunities for Easy approach and the light green square indicates an opportunity for the Plan approach. Note that each square is positioned between circles of the same color as the square. As an example, the green square indicates that there is a market opportunity for a book on the topic of anti-inflammatory diet (the keyphrase) with an easy approach priced between roughly $21 and $24 and having a quality score of between about 75 and 100. The quality scores can be determined based on any appropriate algorithm as long as a consistent algorithm is used for all books in a single user interface. The User interface presents data to an editor or other interested party in a manner that permits a book price, quality and approach to be quickly determined and which book will have a strong market opportunity. As an example, an editor or other analyst can select and area for a book product opportunity (referred to as a “gap” above) that is both: above (by 10+ points) and/or to the left (by $2+) of any competitors with that position, and in an area that was not grayed out. If appropriate, the analyst can adjust inputs in step 1 to modify the areas that are available. For example, there may be a need to have a lower price to be competitive and thus the page count can be lowered. Printing structure and costs can be adjusted, or different sales channels can be selected, etc. to adjust margin accordingly.

The quality score can be calculated based on revenue estimates, target payback periods, page counts, financial margins, and production budget values. All of which can be ascertained based on available data. The minimum price of a book can be based on the page count and associated printing costs. This area can be grayed out in FIG. 3 to eliminate that area as a possible opportunity. Gray out the area below this price.

As noted above, a keyphrase that represents what a representative portion of the consumer market uses to search for items related to the consumer need. The keyphrase can be correlated with:
a revenue estimate for what the representative products earn on a periodic basis that match
one or more recommended position(s) on that keyphrase, the “positions” defining one or more approaches to treating the topic or orienting a product toward one audience among various audiences interested in the topic. the position(s) being recommended because the of one or more of the following:
   the revenue potential of the position on the same or similar keyphrases matching products made by the provider of by comparable competitors is sufficient to justify the cost of production
   the lack or the weakness of competing products on the same or similar position of the same or similar keyphrases
   a revenue estimate for each such position(s) on the keyphrase, indicating what the provider may expect to make given the aforementioned characteristics, optionally adjusted by consideration of the provider's own history of success in making similar products
for at least one recommended position on the keyphrase, one or more windows of production value, defined as any material investment into production of the book-product that adds to its value, such that the recommended product design is to be within the lower and upper limits of that window of value
a break-down of determining such value, such as a weighting in page-length, amount of color photos, credentials of author, quality of paper and binding

For a recommended position on the keyphrase, one or more windows of price-point can be determined, such that the recommended product design is to be within the upper and lower limits of the pricing window. An illustration of how the combination of production value window and pricing window will allow the product to offer a highly competitive vale-to-price ration (“bang for the buck”) to the consumer can be created.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

What is claimed is:

1. A system, the system comprising:
one or more hardware processors configured by machine-readable instructions to:
receive quantitative and qualitative market data from a marketplace indicating consumer interest or demand in book-products;
receive quantitative and qualitative data characteristic data relating to characteristics of existing book-products in the marketplace;
apply at least one formula that determines an opportunity space for at least one potential new book-products based on the market data and the characteristic data, wherein the formula determines, for each of the at least one potential new book product, a consumer need and a keyphrase that represents what a representative portion of the consumer market uses to search for book products related to the consumer need;
store the results of applying the at least one formula in a database; and
create a design for a book product based on the results.

2. The system of claim 1, wherein the result of the at least one formula further specify, for each potential new book product, a revenue estimate of periodic earnings for existing book products that correspond to the keyphrase.

3. The system of claim 1, wherein the result of the at least one formula further specify, for each potential new book product, one or more recommended positions on the keyphrase, wherein the recommended positions indicate one or more approaches to orienting the topic toward one or more various audiences likely to be interested in the topic, wherein the position are based on one or more of the following;
the revenue potential of the position on the same or similar keyphrases matching book products is sufficient to justify the cost of production;
the relative strength of competing products on the same or similar position of the same or similar keyphrases; and
wherein the one or more hardware processors are further configured by machine-readable instructions to for at least one recommended position on the keyphrase, one or more windows of production value such that the recommended book product design is to be within the lower and upper limits of the window of value.

4. The system of claim 3, wherein the result of the at least one formula further specify a break-down of determining the value, including a weighting in page-length, amount of color photos, credentials of author, and quality of paper and binding used to create the book product.

5. The system of claim 3, wherein the result of the at least one formula further specify a revenue estimate for each position on the keyphrase, indicating what a revenue a book product provider may expect to achieve.

6. A method, the method comprising:
receiving quantitative and qualitative market data from a marketplace indicating consumer interest or demand in book-products;
receiving quantitative and qualitative data characteristic data relating to characteristics of existing book-products in the marketplace;
applying at least one formula that determines an opportunity space for at least one potential new book-products based on the market data and the characteristic data, wherein the formula determines, for each of the at least one potential new book product, a consumer need and a keyphrase that represents what a representative portion of the consumer market uses to search for book products related to the consumer need;
storing the results of applying the at least one formula in a database; and
creating a design for a book product based on the results.

7. The method of claim 6, wherein the result of the at least one formula further specify, for each potential new book product, a revenue estimate of periodic earnings for existing book products that correspond to the keyphrase.

8. The method of claim 6, wherein the result of the at least one formula further specify, for each potential new book product, one or more recommended positions on the keyphrase, wherein the recommended positions indicate one or more approaches to orienting the topic toward one or more various audiences likely to be interested in the topic, wherein the position are based on one or more of the following;
the revenue potential of the position on the same or similar keyphrases matching book products is sufficient to justify the cost of production;
the relative strength of competing products on the same or similar position of the same or similar keyphrases; and
for at least one recommended position on the keyphrase, one or more windows of production value such that the recommended book product design is to be within the lower and upper limits of the window of value.

9. The method of claim 8, wherein the result of the at least one formula further specify a break-down of determining the value, including a weighting in page-length, amount of color photos, credentials of author, and quality of paper and binding used to create the book product.

10. The method of claim 8, wherein the result of the at least one formula further specify a revenue estimate for each position on the keyphrase, indicating what a revenue a book product provider may expect to achieve.

11. A non-transient computer-readable storage medium having instructions embodied thereon, the instructions being executable by one or more processors to perform a method, the method comprising:
receiving quantitative and qualitative market data from a marketplace indicating consumer interest or demand in book-products;
receiving quantitative and qualitative data characteristic data relating to characteristics of existing book-products in the marketplace;
applying at least one formula that determines an opportunity space for at least one potential new book-products based on the market data and the characteristic data, wherein the formula determines, for each of the at least one potential new book product, a consumer need and a keyphrase that represents what a representative portion of the consumer market uses to search for book products related to the consumer need;
storing the results of the at least one formula in a database; and
creating a design for a book product based on the results.

12. The computer-readable storage medium of claim 11, wherein the result of the at least one formula further specify, for each potential new book product, a revenue estimate of periodic earnings for existing book products that correspond to the keyphrase.

13. The computer-readable storage medium of claim 11, wherein the result of the at least one formula further specify, for each potential new book product, one or more recommended positions on the keyphrase, wherein the recommended positions indicate one or more approaches to orienting the topic toward one or more various audiences likely to be interested in the topic, wherein the position are based on one or more of the following;
the revenue potential of the position on the same or similar keyphrases matching book products is sufficient to justify the cost of production;
the relative strength of competing products on the same or similar position of the same or similar keyphrases; and
wherein the method for at least one recommended position on the keyphrase, one or more windows of production value such that the recommended book product design is to be within the lower and upper limits of the window of value.

14. The computer-readable storage medium of claim 13, wherein the result of the at least one formula further specify a break-down of determining the value, including a weighting in page-length, amount of color photos, credentials of author, and quality of paper and binding used to create the book product.

15. The computer-readable storage medium of claim 13, wherein the result of the at least one formula further specify a revenue estimate for each position on the keyphrase, indicating what a revenue a book product provider may expect to achieve.

16. The system of claim 1, wherein the one or more hardware processors are further configured by machine-readable instructions to display the opportunity space is displayed on a user interface as a chart of book products corresponding to a keyphrase as groups by approach to a category related to the keyphrase, wherein the x axis is cost and the y axes relates to production value and wherein the design for the book product is created by detecting gaps between the groups.

17. The method of claim 67, further comprising displaying the opportunity space on a user interface as a chart of book products corresponding to a keyphrase as groups by approach to a category related to the keyphrase, wherein the x axis is cost and the y axes relates to production value and wherein the design for the book product is created by detecting gaps between the groups.
The media of claim 11, wherein the instructions further cause the processors to display the opportunity space is displayed on a user interface as a chart of book products corresponding to a keyphrase as groups by approach to a category related to the keyphrase, wherein the x axis is cost and the y axes relates to production value and wherein the design for the book product is created by detecting gaps between the groups.
